(19) United States
(12) Patent Application Publication
(10) Pub. No.: US 2014/0077536 A1
(43) Pub. Date: Mar. 20, 2014

(54) FOLD-FLAT SEAT ASSEMBLY

(71) Applicant: Carl Mather, Lake Orion, MI (US)

(72) Inventor: Carl Mather, Lake Orion, MI (US)

(73) Assignee: CHRYSLER GROUP LLC, Auburn Hills, MI (US)

(21) Appl. No.: 13/621,352

(22) Filed: Sep. 17, 2012

(51) Int. Cl. B60N 2/20; B60N 2/44; B60N 2/02

(52) U.S. Cl. 297/188.08; 297/313; 297/188.01

(57) ABSTRACT

A seat assembly may include a seat bottom and a seatback. The seat bottom may include a seating surface and a first cargo surface. The seat bottom may be movable between a first position in which the seating surface may face upward and a second position in which the first cargo surface may face upward and the seating surface may face downward. The seatback may include a backrest surface and a second cargo surface. The seatback may be movable relative to the seat bottom between a third position in which the backrest surface may face a front end of the seat assembly and a fourth position in which the second cargo surface may face upward and is substantially level with the first cargo surface when the seat bottom is in the first position.

### FIELD

The present disclosure relates to a fold-flat seat assembly for a vehicle.

### BACKGROUND

Automotive vehicles include seat assemblies for supporting occupants within a cabin of the vehicle. Some seat assemblies are able to be removed from the vehicle by a user or moved by the user between a seating position and a stowed position to tradeoff passenger seating space for additional cargo space within the cabin of the vehicle. Removing seat assemblies from a vehicle can be cumbersome and storage of a removed seat assembly can be troublesome. Stowable seat assemblies provide the convenience of being able to quickly and easily switch between additional seating space and additional cargo space within the cabin of the vehicle without the heavy lifting or storage hassles associated with removable seat assemblies.

### SUMMARY

The present disclosure provides a seat assembly that may include a seat bottom and a seatback. The seat bottom may include a seating surface and a first cargo surface. The seat bottom may be movable between a first position in which the seating surface may face upward and a second position in which the first cargo surface may face upward and the seating surface may face downward. The seatback may include a backrest surface and a second cargo surface. The seatback may be movable relative to the seat bottom between a third position in which the backrest surface may face a front end of the seat assembly and a fourth position in which the second cargo surface may face upward and is substantially level with the first cargo surface when the seat bottom is in the first position.

In some embodiments, the seat bottom and seatback may be movable independently of each other.

In some embodiments, the seat bottom may substantially cover a first storage container in the first position and may uncover the first storage container in the second position. In some embodiments, the seatback may substantially cover the first storage container in the fourth position and may uncover the first storage container in the third position. In some embodiments, the seatback may substantially cover a second storage container in the third position and may uncover the second storage container in the fourth position. In some embodiments, the second storage container may be disposed between the seatback and a back wall panel that defines a rearward boundary of a cabin of a vehicle in which the seat assembly is installed when the seatback is in the third position.

In some embodiments, the seat bottom may include first and second portions that are movable independently of each other between the first and second positions. The first portion may include approximately sixty percent of the seat bottom and the second portion may include approximately forty percent of the seat bottom.

In some embodiments, the seatback may include third and fourth portions that are movable independently of each other between the third and fourth positions. The third portion may include approximately sixty percent of the seatback and the fourth portion may include approximately forty percent of the seatback.

In some embodiments, the seatback may form a part of a four-bar linkage that moves the seatback between the third and fourth positions. In some embodiments, the seat bottom may include a pivot about which the seat bottom is rotatable between the first and second positions.

In another form, the present disclosure provides a vehicle that may include a vehicle body, a seat bottom and a seatback. The vehicle body may include an occupant cabin defined by a floor, a ceiling and a back wall. The seat bottom may be disposed within the occupant cabin and may include a seating surface and a first cargo surface. The seat bottom may be movable relative to the floor between a first position in which the seating surface is facing away from the floor and a second position in which the first cargo surface is facing the ceiling and the seating surface is facing toward the floor. The seatback may be disposed within the occupant cabin and may include a backrest surface and a second cargo surface. The seatback may be movable relative to the seat bottom between a third position in which the backrest surface is facing away from the back wall and a fourth position in which the second cargo surface is facing the ceiling and is substantially level with the first cargo surface when the seat bottom is in the first position.

In some embodiments, the seat bottom and seatback may be movable independently of each other.

In some embodiments, the seat bottom may substantially cover a first storage container in the first position and uncover the first storage container in the second position.

In some embodiments, the seatback may substantially cover the first storage container in the fourth position and uncover the first storage container in the third position.

In some embodiments, the seatback may substantially cover a second storage container in the third position and uncover the second storage container in the fourth position.

In some embodiments, the first storage container may be disposed between the seat bottom and the floor when the seat bottom is in the first position. The second storage container may be disposed between the seatback and the back wall when the seatback is in the third position.

In some embodiments, the seatback may substantially cover a storage container in the third position and uncover the storage container in the fourth position.

In some embodiments, the seat bottom may include first and second portions that are movable independently of each other between the first and second positions. The first portion may include approximately sixty percent of the seat bottom and the second portion may include approximately forty percent of the seat bottom.

In some embodiments, the seatback may include third and fourth portions that are movable independently of each other between the third and fourth positions. The third portion may include approximately sixty percent of the seatback and the fourth portion may include approximately forty percent of the seatback.

In some embodiments, the seatback may form a part of a four-bar linkage that moves the seatback between the third and fourth positions. The seat bottom may include a pivot about which the seat bottom is rotatable between the first and second positions.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle having a rear seat assembly according to the principles of the present disclosure;

FIG. 2 is a partial perspective view of an occupant cabin of the vehicle including the rear seat assembly in first configuration;

FIG. 3 is another partial perspective view of the occupant cabin including the rear seat assembly in another configuration;

FIG. 4 is another partial perspective view of the occupant cabin including the rear seat assembly in another configuration;

FIG. 5 is another partial perspective view of the occupant cabin including the rear seat assembly in another configuration;

FIG. 6 is another partial perspective view of the occupant cabin including the rear seat assembly in another configuration;

FIG. 7 is another partial perspective view of the occupant cabin including the rear seat assembly in another configuration; and

FIG. 8 is a partial side view of the occupant cabin depicting the rear seat assembly in a seating position in solid lines and a cargo position in phantom lines.

### DETAILED DESCRIPTION

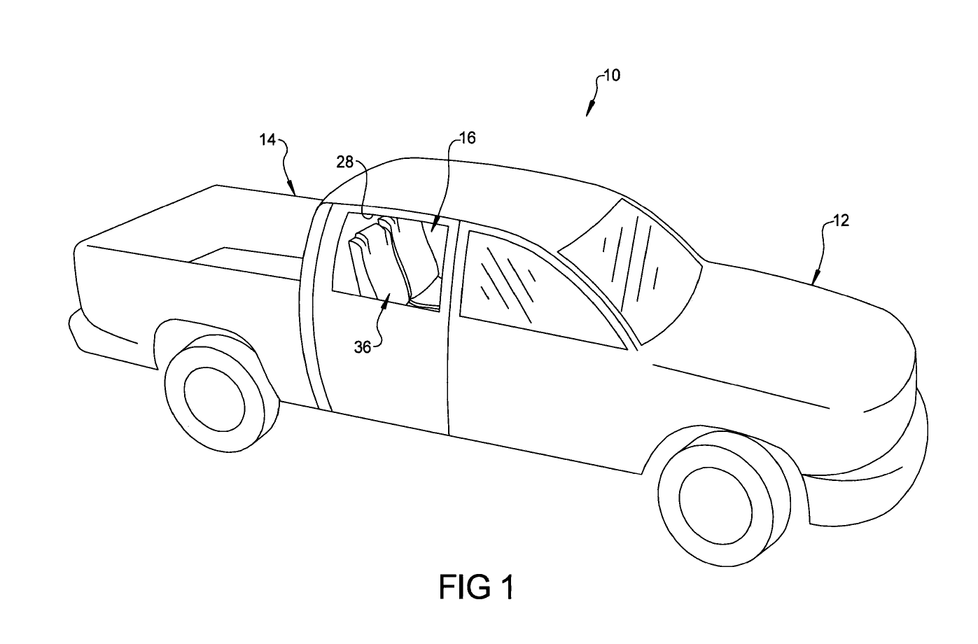

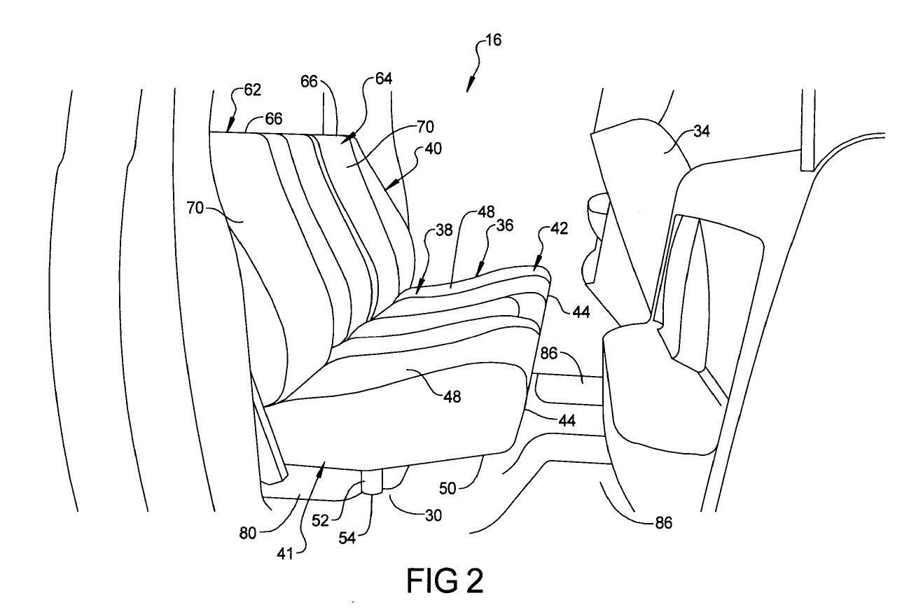

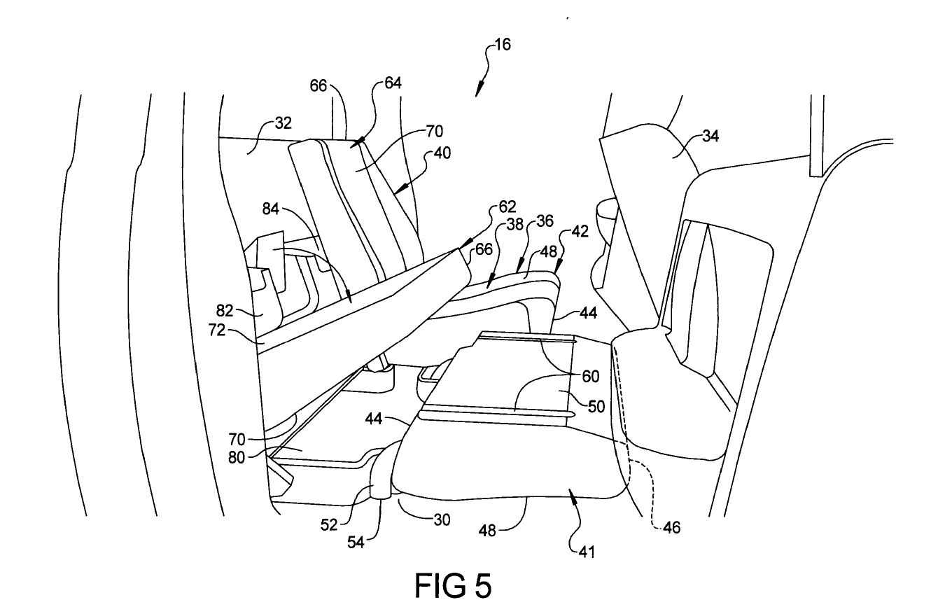

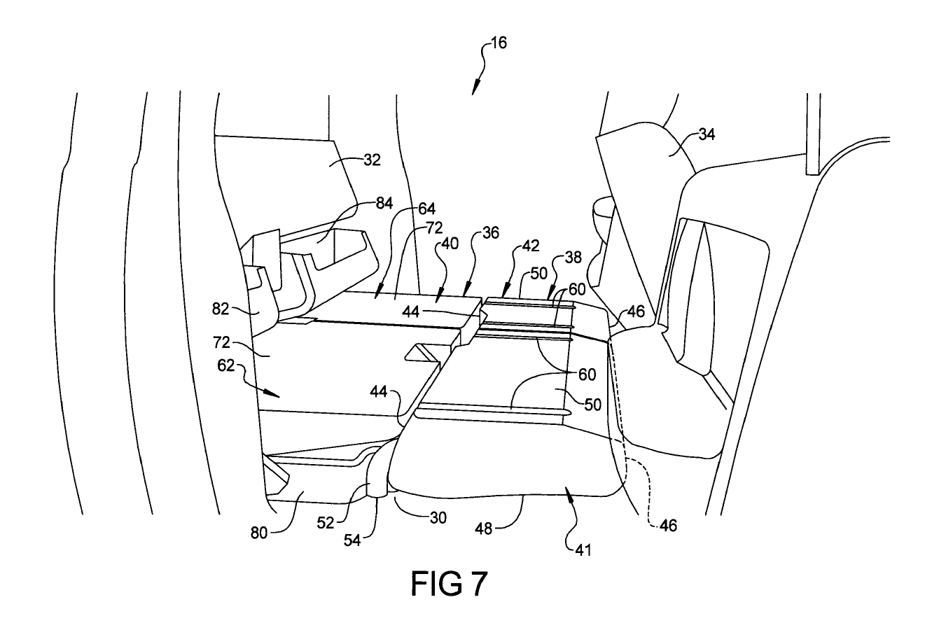

In an exemplary embodiment and with reference to FIGS. 1-8, a vehicle 10 is provided that may include a body 12 having a cargo bed 14 and an occupant cabin 16. The cargo bed 14 may be an open compartment disposed in a rear portion of the vehicle 10 behind the occupant cabin 16. The occupant cabin 16 may be a space defined by a ceiling panel 28, a floor panel 30 and a back-wall panel 32 (shown in FIGS. 5-8). The occupant cabin 16 may include one or more front seat assemblies 34 (partially shown in FIGS. 2-7) and a rear seat assembly 36. The rear seat assembly 36 may be movable between a seating position (shown in FIG. 2) and a cargo position (shown in FIG. 7). In the cargo position, the rear seat assembly 36 may form a substantially flat, uniform surface upon which cargo can be placed. Furthermore, in some embodiment, the flat surface formed by the rear seat assembly 36 in the cargo position may be at a vertical height (relative to the ground) that is convenient for an average-height user. While the vehicle 10 is depicted in the figures as a pick-up truck, it will be appreciated that the vehicle 10 could be a sedan, a coupe, a wagon, a hatch-back, a sport-utility vehicle, a crossover, a van, a minivan or any other type of consumer, commercial, industrial or military vehicle.

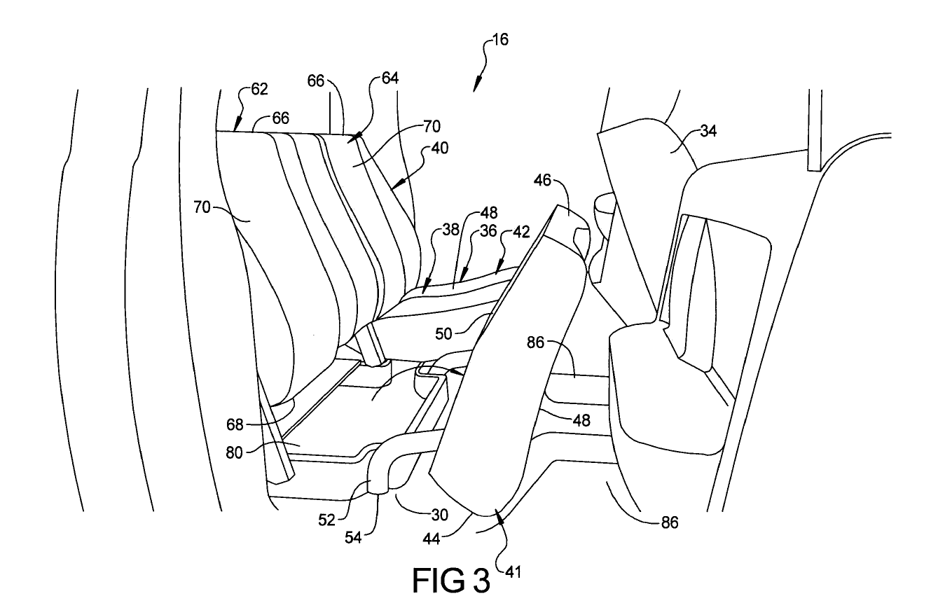

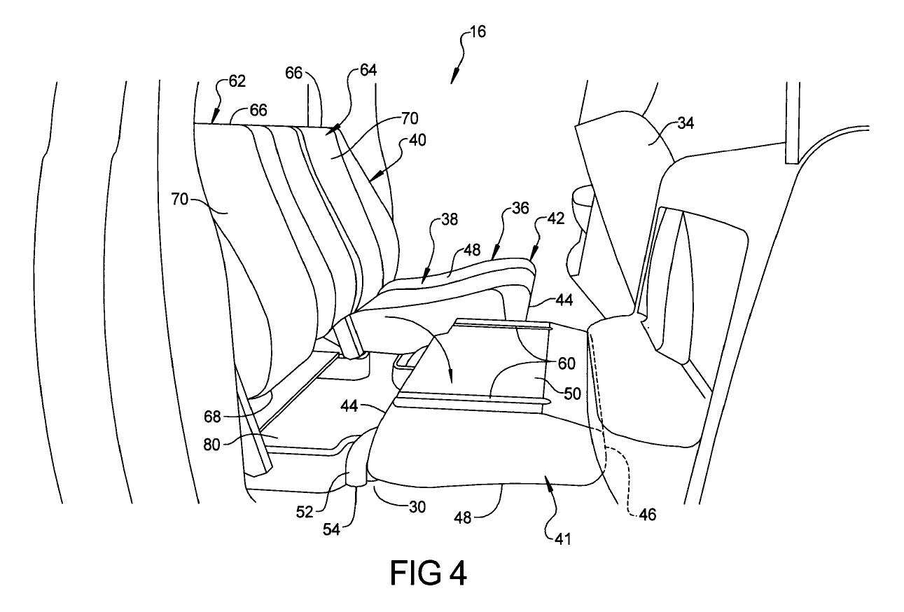

The rear seat assembly 36 may include a seat bottom 38 and a seatback 40 that may be movable independently of each other. The seat bottom 38 may include first and second portions 41, 42 that may be movable independently of each other between the seating and cargo positions (as shown in FIG. 4). In some embodiments, the first portion 41 may form about sixty percent of the seat bottom 38 (i.e., the first portion 41 may include a window-seat and a middle seat) and the second portion 42 may form about forty percent of the seat bottom 38 (i.e., the second portion 42 may include another window-seat). Each of the first and second portions 41, 42 of the seat bottom 38 may include a first end 44, a second end 46 (FIGS. 3-8), a seating surface 48 and a cargo surface 50. As shown in FIG. 2, when the rear seat assembly 36 is in the seating position, the seating surface 48 may face generally upward toward the ceiling panel 28, the cargo surface 50 may face generally downward toward the floor panel 30, the first end 44 may face generally toward a front end of the vehicle 10, and the second end 46 may face generally toward a rear end of the vehicle 10. In the cargo position (FIG. 7), the seating surface 48 may face generally upward toward the floor panel 30, the cargo surface 50 may face generally downward toward the ceiling panel 28, the first end 44 may face generally toward the rear end of the vehicle 10, and the second end 46 may face generally toward the front end of the vehicle 10.

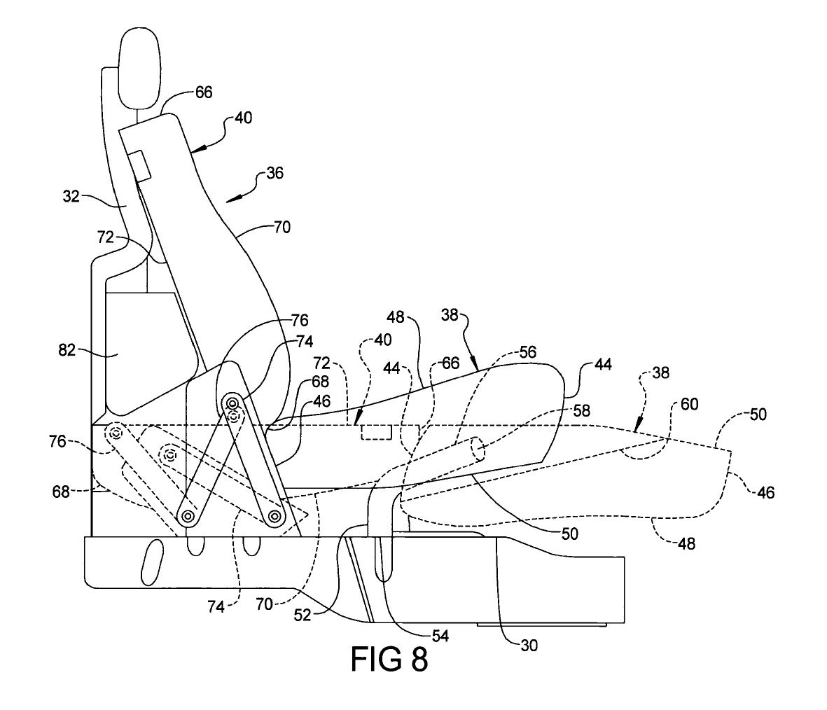

Each of the first and second portions 41, 42 of the seat bottom 38 may be pivotably mounted to a corresponding pair of generally L-shaped members 52. Each of the members 52 may include a first end 54 fixed to the floor panel 30 or to a suitable structure adjacent the floor panel 30 and a second end 56 (FIG. 8) rotatably engaging a corresponding anchor 58 (shown schematically in FIG. 8) attached to the seat bottom 38.

The anchors 58 may be disposed between and spaced apart from the first and second ends 44, 46 of the corresponding portion 41, 42 of the seat bottom 38 and may be between and spaced apart from the seating and cargo surfaces 48, 50 of the corresponding portion 41, 42 of the seat bottom 38. Each of the first and second portions 41, 42 of the seat bottom 38 may also include a pair of slots 60 (shown in FIGS. 4-8) that extend through the cargo surface 50 and the second end 46. Each anchor 58 may be disposed inside of a corresponding slot 60. The slots 60 provide clearance for the second ends 56 the members 52 to allow the seat bottom 38 to rotate relative to the members 52 between the seating position and the cargo position.

The seatback 40 may include first and second portions 62, 64 that may be movable independently of each other between the seating and cargo positions (as shown in FIG. 5). The first portion 62 may form about sixty percent of the seat bottom 38 (i.e., the first portion 62 may correspond to the first portion 41 of the seat bottom 38) and the second portion 64 may form about forty percent of the seat bottom 38 (i.e., the second portion 64 may correspond to the second portion 42 of the seat bottom 38). Each of the first and second portions 62, 64 of the seatback 40 may include a first end 66, a second end 68 (FIGS. 3, 4 and 8), a backrest surface 70 and a cargo surface 72 (FIGS. 5-8). As shown in FIG. 2, when the rear seat assembly 36 is in the seating position, the backrest surface 70 may face generally toward a front end of the vehicle 10, the cargo surface 50 may face generally toward a rear end of the vehicle 10, the first end 66 may face generally upward toward the ceiling panel 28, and the second end 68 may face generally downward toward the floor panel 30. In the cargo position (FIG. 7), the backrest surface 70 may face generally downward toward the floor panel 30, the cargo surface 72 may face generally upward toward the ceiling panel 28, the first end 66 may face generally toward the front end of the vehicle 10, and the second end 68 may face generally toward the rear end of the vehicle 10.

As shown in FIG. 8, each of the first and second portions 62, 64 of the seatback 40 may be movably connected to the floor panel 30 by a corresponding pair of first links 74 and a pair of second links 76. The first and second links 74, 76 may be pivotably coupled to the floor panel 30 or a suitable structure adjacent the floor panel 30 and may be pivotably coupled to the second end 68 of the corresponding one of the first and second portions 62., 64 of the seatback 40. Locking mechanisms (not shown) may selectively lock the first and second portions 62, 64 in the seating position until a user releases one or both of the locking mechanisms to move the first and/or second portions 62, 64 toward the cargo position.

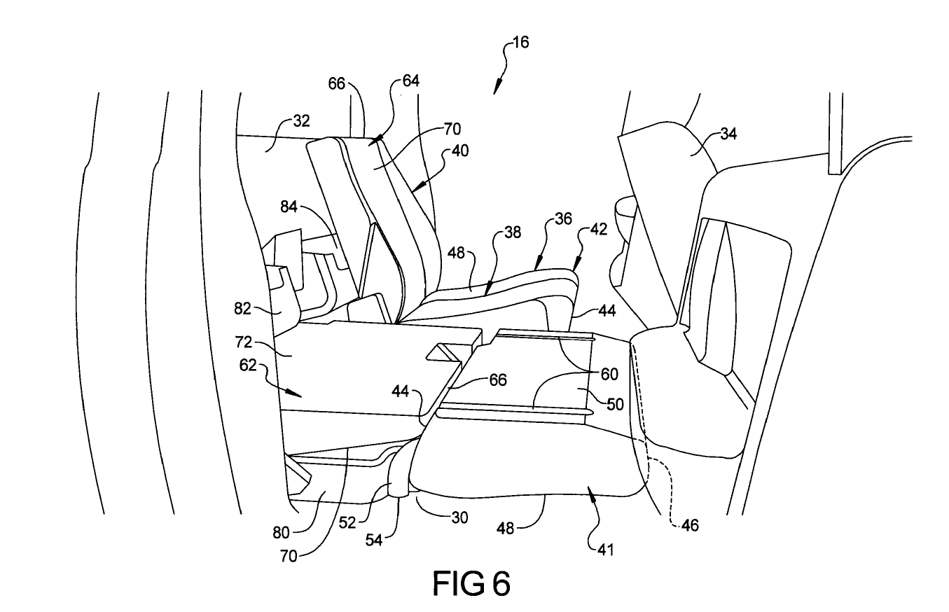

The first and second links 74, 76 can rotate the seatback 40 from the seating position to the cargo position such that the first ends 66 of the seatback 40 may abut the first ends 44 of the seat bottom 38 in the cargo position (shown in FIGS. 6 and 7). Furthermore, the cargo surfaces 72 of the seatback 40 may be substantially coplanar with the cargo surfaces 50 of the seat bottom 38 when the rear seat assembly 36 is in the cargo position. This relative positioning of the seatback 40 and seat bottom 38 provides a substantially flat surface upon which a user may place cargo.

The occupant cabin 16 may also include first, second and third storage bins 80, 82, 84. The first storage bin 80 may be disposed on or integrally formed with the floor panel 30. The first and second portions 41, 42 of the seat bottom 38 may cover respective portions of the first storage bin 80 in the seating positions. Therefore, when the first and second portions 41, 42 of the seat bottom 38 are in the seating positions, access to the first storage bin 80 may be restricted or prevented. When the first and/or second portions 41, 42 are moved out of the seating position toward the cargo position, the first storage bin 80 may be exposed to allow access to the first storage bin 80. When the seat bottom 38 is in the cargo position, access to the first storage bin 80 can also be restricted or prevented by moving the seatback 40 into the cargo position.

The second and third storage bins 82, 84 may be attached to or integrally formed with the back-wall panel 32. Access to the second and third storage bins 82, 84 may be restricted or prevented when the first and second portions 62, 64 of the seatback 40, respectively, are in the seating position. To access the second and/or third storage bins 82, 84, the user may move the corresponding one of the first and second portions 62, 64 of the seatback 40 toward the cargo position. In some embodiments, the second and third storage bins 82, 84 may be sized to fit in foot wells 86 (FIGS. 2 and 3) formed in the floor panel 30 and covered by the first and second portions 41, 42 of the seat bottom 38 in the cargo position.

Some or all of the storage bins 80, 82, 84 may be removable or permanently attached to the floor panel 30 and back-wall panel 32, respectively. While not shown in the figures, the storage bins 80, 82, 84 could include lids. In some embodiments, the lids may include locks. It will be appreciated that the first storage bin 80 may be a single bin, as shown in the figures, or the first storage bin 80 could be divided into first and second separate portions that correspond to the first and second portions 41, 42 of the seat bottom 38. Similarly, the second and third storage bins 82, 84 could be separate bins, as shown in the figures, or the second and third storage bins 82, 84 could be integrated into a single bin.

While the seat assembly 36 is described above and shown in the figures as being a rear seat assembly, it will be appreciated that a front seat assembly could be provided with the structure and functionality of the seat assembly 36. Additionally or alternatively, the seat assembly 36 could be second or third row seat assemblies in a minivan or sport-utility vehicle, for example.

What is claimed is:

1. A seat assembly comprising:
a seat bottom including a seating surface and a first cargo surface, the seat bottom being movable between a first position in which the seating surface is facing upward and a second position in which the first cargo surface is facing upward and the seating surface is facing downward; and
a seatback including a backrest surface and a second cargo surface, the seatback being movable relative to the seat bottom between a third position in which the backrest surface is facing a front end of the seat assembly and a fourth position in which the second cargo surface is facing upward and is substantially level with the first cargo surface when the seat bottom is in the first position.

2. The seat assembly of claim 1, wherein the seat bottom and seatback are movable independently of each other.

3. The seat assembly of claim 1, wherein the seat bottom substantially covers a first storage container in the first position and uncovers the first storage container in the second position.

4. The seat assembly of claim 3, wherein the seatback substantially covers the first storage container in the fourth position and uncovers the first storage container in the third position.

5. The seat assembly of claim 4, wherein the seatback substantially covers a second storage container in the third position and uncovers the second storage container in the fourth position.

6. The seat assembly of claim 1, wherein the seatback substantially covers a storage container in the third position and uncovers the storage container in the fourth position.

7. The seat assembly of claim 6, wherein the storage container is disposed between the seatback and a back wall panel that defines a rearward boundary of a cabin of a vehicle in which the seat assembly is installed when the seatback is in the third position.

8. The seat assembly of claim 1, wherein the seat bottom includes first and second portions that are movable independently of each other between the first and second positions, and wherein the first portion includes approximately sixty percent of the seat bottom and the second portion includes approximately forty percent of the seat bottom.

9. The seat assembly of claim 8, wherein the seatback includes third and fourth portions that are movable independently of each other between the third and fourth positions, and wherein the third portion includes approximately sixty percent of the seatback and the fourth portion includes approximately forty percent of the seatback.

10. The seat assembly of claim 1, wherein the seatback forms a part of a four-bar linkage that moves the seatback between the third and fourth positions, and wherein the seat bottom includes a pivot about which the seat bottom is rotatable between the first and second positions.

11. A vehicle comprising:
a vehicle body including an occupant cabin defined by a floor, a ceiling and a back wall;
a seat bottom disposed within the occupant cabin and including a seating surface and a first cargo surface, the seat bottom being movable relative to the floor between a first position in which the seating surface is facing away from the floor and a second position in which the first cargo surface is facing the ceiling and the seating surface is facing toward the floor; and
a seatback disposed within the occupant cabin and including a backrest surface and a second cargo surface, the seatback being movable relative to the seat bottom between a third position in which the backrest surface is facing away from the back wall and a fourth position in which the second cargo surface is facing the ceiling and is substantially level with the first cargo surface when the seat bottom is in the first position.

12. The vehicle of claim 11, wherein the seat bottom and seatback are movable independently of each other.

13. The vehicle of claim 11, wherein the seat bottom substantially covers a first storage container in the first position and uncovers the first storage container in the second position.

14. The vehicle of claim 13, wherein the seatback substantially covers the first storage container in the fourth position and uncovers the first storage container in the third position.

15. The vehicle of claim 14, wherein the seatback substantially covers a second storage container in the third position and uncovers the second storage container in the fourth position.

16. The vehicle of claim 15, wherein the first storage container is disposed between the seat bottom and the floor when the seat bottom is in the first position, and wherein the second storage container is disposed between the seatback and the back wall when the seatback is in the third position.

17. The vehicle of claim 11, wherein the seatback substantially covers a storage container in the third position and uncovers the storage container in the fourth position.

18. The vehicle of claim 11, wherein the seat bottom includes first and second portions that are movable independently of each other between the first and second positions, and wherein the first portion includes approximately sixty percent of the seat bottom and the second portion includes approximately forty percent of the seat bottom.

19. The vehicle of claim 18, wherein the seatback includes third and fourth portions that are movable independently of each other between the third and fourth positions, and wherein the third portion includes approximately sixty percent of the seatback and the fourth portion includes approximately forty percent of the seatback.

20. The vehicle of claim 11, wherein the seatback forms a part of a four-bar linkage that moves the seatback between the third and fourth positions, and wherein the seat bottom includes a pivot about which the seat bottom is rotatable between the first and second positions.
